(19) United States
(12) Patent Application Publication
(10) Pub. No.: US 2026/0117096 A1
(43) Pub. Date: Apr. 30, 2026

(54) SHEET-SHAPED BONDING MATERIAL AND METHOD OF PRODUCING SAME, AND BONDED BODY AND METHOD OF PRODUCING SAME

(71) Applicant: TAIYO NIPPON SANSO CORPORATION, Shinagawa-ku, Tokyo (JP)

(72) Inventors: Kentaro MIYOSHI, Shinagawa-ku, Tokyo (JP); Hiroshi IGARASHI, Shinagawa-ku, Tokyo (JP)

(73) Assignee: TAIYO NIPPON SANSO CORPORATION, Shinagawa-ku, Tokyo (JP)

(21) Appl. No.: 19/125,998

(22) PCT Filed: Oct. 24, 2023
(86) PCT No.: PCT/JP2023/038369

§ 371 Date: Apr. 30, 2025

(30) Foreign Application Priority Data
Nov. 16, 2022 (JP) 2022-183651

(51) Int. Cl. C09J 7/35; B32B 7/12; B32B 9/00; B32B 9/04; B32B 15/20; C09J 5/06

(52) U.S. Cl. CPC C09J 7/35; B32B 7/12; B32B 9/005; B32B 9/041; C09J 5/06; B32B 15/20; B32B 2250/02; B32B 2255/205; B32B 2264/1055; B32B 2264/302; B32B 2311/12; C09J 2301/304; C09J 2400/16

(57) ABSTRACT

Provided is a bonding material that even in low-temperature bonding at 250° C. or lower, enables bonding with sufficient bonding strength and with low tendency for unevenness between a sinter state of a central section and a sinter state of a pressed edge section at a pressure bonding surface. A sheet-shaped bonding material contains copper particles and a reductant that reduces the copper particles. The copper particles include fine copper particles having a mean particle diameter of 300 nm or less and optionally include coarse copper particles having a mean particle diameter of 3-11 μm. Content of the fine copper particles relative to the total content of the fine copper particles and the coarse copper particles is 50-100 mass %. The reductant is composed of triethanolamine, and content of the triethanolamine is 1.5-10.0 mass % relative to the total content of the fine copper particles and the coarse copper particles.

### TECHNICAL FIELD

The present disclosure relates to a sheet-shaped bonding material and method of producing the same and also relates to a bonded body and method of producing the same.

### BACKGROUND

Solder materials have conventionally been used widely as bonding materials for electronic components. However, solder materials have been problematic in terms of having poor heat resistance. Consequently, it has been difficult to use solder materials as bonding materials in power devices including SiC elements that are expected to be used at high temperatures of 150° C. or higher, for example.

Therefore, bonding materials in which silver particles are used have been proposed as sinter-type bonding materials. The use of copper nanoparticles is also promising from viewpoints of cost and ion migration.

Patent Literature (PTL) 1 discloses “a plate-shaped or sheet-shaped bonding material comprising a sinter of fine particles having a mean particle diameter of 300 nm or less and having copper as a main component, wherein a specific resistance value of the bonding material is 1×10⁻⁵ Ω·m or less”, and also discloses that this bonding material can display high bonding force even in a situation in which two or more bonded members have been bonded in an inert atmosphere.

However, although bonding in an inert atmosphere can be achieved in PTL 1, the copper nanoparticles are sintered while being pressed in a reducing atmosphere during production of the sheet-shaped bonding material, and thus this production requires a reducing gas and is restrictive in terms of gas equipment for waste gas treatment, etc. Moreover, since the copper nanoparticles are sintered through a reducing gas, there have also been problems of loss of surface activity characteristic of the nanoparticles and instability of performance depending on the sinter state.

In response, PTL 2 and PTL 3 each propose a sheet-shaped bonding material that enables stable bonding in an inert atmosphere without the need for a reducing gas during bonding due to a reductant being added in production of the sheet-shaped bonding material. Specifically, PTL 2 discloses “a plate-shaped or sheet-shaped bonding material comprising fine copper particles having copper as a main component and having a mean particle diameter of 300 nm or less, wherein the bonding material further comprises a reductant that reduces the fine copper particles”, and PTL 3 discloses “a plate-shaped or sheet-shaped bonding material comprising fine copper particles having a mean particle diameter of 300 nm or less, coarse copper particles having a mean particle diameter of not less than 3 μm and not more than 11 μm, and a reductant that reduces the fine copper particles and the coarse copper particles”. A polyol solvent such as ethylene glycol or an organic acid is given as an example of the reductant.

### CITATION LIST

### Patent Literature

PTL 1: JP2018-12871A
PTL 2: JP2019-203172A
PTL 3: JP2021-116450A

### SUMMARY

### Technical Problem

However, with the sheet-shaped bonding materials described in PTL 2 and PTL 3, a reducing effect of the reductant is not sufficiently displayed during low-temperature bonding at 250° C. or lower, thus resulting in problems such as insufficient bonding strength and unevenness between a sinter state of a central section and a sinter state of a pressed edge section at a pressure bonding surface.

In view of the problem described above, one object of the present disclosure is to provide a bonding material that even in low-temperature bonding at 250° C. or lower, enables bonding with sufficient bonding strength and with low tendency for unevenness between a sinter state of a central section and a sinter state of a pressed edge section at a pressure bonding surface, and also to provide a suitable method of producing the bonding material.

Another object of the present disclosure is to provide a bonded body in which good bonding such as described above is realized through use of such a bonding material, and also to provide a suitable method of producing the bonded body.

### Solution to Problem

Primary configurations of the present disclosure for solving the problem described above are as follows.
[1] A sheet-shaped bonding material comprising copper particles and a reductant that reduces the copper particles, wherein
the copper particles include fine copper particles having a mean particle diameter of 300 nm or less and optionally include coarse copper particles having a mean particle diameter of not less than 3 μm and not more than 11 μm,
content of the fine copper particles relative to the total content of the fine copper particles and the coarse copper particles is not less than 50 mass % and not more than 100 mass %, and
the reductant is composed of triethanolamine, and content of the triethanolamine is not less than 1.5 mass % and not more than 10.0 mass % relative to the total content of the fine copper particles and the coarse copper particles.
[2] The sheet-shaped bonding material according to the foregoing [1], wherein a ratio of mass oxygen concentration relative to specific surface area of the fine copper particles is not less than 0.1 mass %·g/m² and not more than 1.2 mass %·g/m².
[3] The sheet-shaped bonding material according to the foregoing [1] or [2], wherein a ratio of mass carbon concentration relative to specific surface area of the fine copper particles is not less than 0.008 mass %·g/m² and not more than 0.3 mass %·g/m².
[4] A method of producing a sheet-shaped bonding material comprising:
a mixing step of mixing copper particles and a reductant that reduces the copper particles to obtain a mixture; and
a pressure forming step of pressure forming the mixture to obtain a sheet-shaped bonding material, wherein
the copper particles include fine copper particles having a mean particle diameter of 300 nm or less and optionally include coarse copper particles having a mean particle diameter of not less than 3 μm and not more than 11 μm,
content of the fine copper particles relative to the total content of the fine copper particles and the coarse copper particles in the mixture is not less than 50 mass % and not more than 100 mass %, and
the reductant is composed of triethanolamine, and content of the triethanolamine in the mixture is not less than 1.5 mass % and not more than 10.0 mass % relative to the total content of the fine copper particles and the coarse copper particles.
[5] The method of producing a sheet-shaped bonding material according to the foregoing [4], wherein the mixing step includes: a step of mixing the copper particles, the reductant, and an organic solvent to obtain a slurry; and a step of drying the slurry to obtain the mixture.
[6] A bonded body comprising a first member, a second member, and the bonding material according to any one of the foregoing [1] to [3], wherein the bonding material is located between the first member and the second member.
[7] A method of producing a bonded body comprising a step of performing pressing in a state in which the bonding material according to any one of the foregoing [1] to [3] is arranged between a first member and a second member to obtain a bonded body in which the first member and the second member are bonded through the bonding material.
[8] The method of producing a bonded body according to the foregoing [7], wherein a bonding temperature is set to 250° C. or lower.

### Advantageous Effect

Through a bonding material according to the present disclosure, bonding is possible with sufficient bonding strength and with low tendency for unevenness between a sinter state of a central section and a sinter state of a pressed edge section at a pressure bonding surface even in low-temperature bonding at 250° C. or lower. Through a method of producing a bonding material according to the present disclosure, it is possible to produce such a bonding material.

In a bonded body according to the present disclosure, good bonding such as described above is realized using such a bonding material. Through a method of producing a bonded body according to the present disclosure, it is possible to produce a bonded body in which good bonding such as described above is realized using such a bonding material.

### DETAILED DESCRIPTION

### [Sheet-Shaped Bonding Material]

A sheet-shaped bonding material according to one embodiment of the present disclosure contains copper particles and a reductant that reduces the copper particles. The copper particles include fine copper particles (also referred to as “copper nanoparticles”) and coarse copper particles, and are preferably composed of the fine copper particles and the coarse copper particles. The term “fine copper particles” as used here means copper particles having a particle diameter of less than 800 nm, whereas the term “coarse copper particles” as used here means copper particles having a particle diameter of 800 nm or more.

### (Fine Copper Particles)

The fine copper particles have copper as a main component. The fine copper particles preferably contain not less than 95 mass % and not more than 100 mass % of copper element, and more preferably contain 97 mass % or more of copper element relative to 100 mass % of the fine copper particles. The inclusion of 95 mass % or more of copper element results in the bonding material having excellent heat resistance and even better bonding force.

The mean particle diameter of the fine copper particles is 300 nm or less. However, it is more preferable that the mean particle diameter of the fine copper particles is 150 nm or less. Through the mean particle diameter of the fine copper particles being 300 nm or less, the bonding material has excellent bonding force. The mean particle diameter of the fine copper particles is preferably 5 nm or more. When the mean particle diameter of the fine copper particles is 5 nm or more, this makes it easy to acquire the fine copper particles.

The particle size distribution of the fine copper particles does not overlap with the particle size distribution of the coarse copper particles. For example, the particle size distribution of the fine copper particles can be a particle size distribution having a D10 of 40 nm, a D50 of 110 nm, and a D90 of 300 nm.

No specific limitations are placed on the shape (form) of the fine copper particles. The shape of the fine copper particles may be a spherical shape (sphere), an elliptical shape (ellipsoid), a plate shape, or the like, of which, a spherical shape or an elliptical shape is preferable, and a spherical shape is more preferable.

The mean particle diameter of the fine copper particles can be determined by observing 10 viewing fields at ×10,000 magnification using a scanning electron microscope (SEM), measuring the particle diameter of each fine copper particle among all fine copper particles (copper particles having a particle diameter of less than 800 nm) selected according to the following selection criteria (1) to (5) in the 10 viewing fields, and calculating an arithmetic mean of the measured particle diameters. Note that in the case of a particle that is an ellipse or the like rather than a perfect circle, the major axis is taken to be the particle diameter. The particle size distribution of the fine copper particles is also determined based on the particle diameters of all fine copper particles taken as the measurement subjects described above. In a situation in which the mean particle diameter and the particle size distribution of the fine copper particles are to be determined with the fine copper particles in the sheet-shaped bonding material, an outermost surface portion of the sheet is observed. In the case of a powder state prior to sheet production, the powder is placed on carbon tape using a spatula, excess powder is removed by an air duster, and the surface of the tape is observed.
(1) Particles that partially protrude outside of a viewing field of an image are not measured.
(2) Particles that have a clear contour and are present in isolation are measured.
(3) Particles that are independent and can be measured as individual particles are measured even when they deviate from the average particle shape.
(4) Overlapping particles for which there is a clear boundary between the particles and for which the overall particle shape can be judged are each measured as an individual particle.
(5) Overlapping particles for which there is not a clear boundary and for which the overall particle shape is unknown are considered to have particle shapes that cannot be judged and are not measured.

The fine copper particles are preferably fine copper particles that do not require a protective agent, a dispersant, or the like. Examples of such fine copper particles include ultrafine metal powder obtained through a production method described in JP4304221B2. However, the fine copper particles are not limited to this example.

The fine copper particles preferably have a coating film containing copper carbonate at the surface. The inclusion of a coating film containing copper carbonate at the surface of the fine copper particles makes it possible to increase bonding force while also restricting the sintering temperature of the fine copper particles to a lower temperature than conventionally adopted. Moreover, sintering of the fine copper particles containing copper carbonate causes necking with the coarse copper particles and results in strengthening of the whole fired layer of copper. The coating film containing copper carbonate may further contain cuprous oxide.

A ratio of the mass oxygen concentration relative to the specific surface area of the fine copper particles is preferably 0.1 mass %·g/m² or more, and more preferably 0.2 mass %·g/m² or more from a viewpoint of lowering reactivity with oxygen in air and reducing the influence of reoxidation. On the other hand, the ratio of the mass oxygen concentration relative to the specific surface area of the fine copper particles is preferably 1.2 mass %·g/m² or less, and more preferably 0.5 mass %·g/m² or less from a viewpoint of facilitating removal of an oxide film during bonding and further increasing bonding force.

A ratio of the mass carbon concentration relative to the specific surface area of the fine copper particles is preferably 0.3 mass %·g/m² or less, more preferably 0.1 mass %·g/m² or less, and even more preferably 0.05 mass %·g/m² or less from a viewpoint of inhibiting the formation of voids and cracks and further increasing bonding force. The ratio of the mass carbon concentration relative to the specific surface area of the fine copper particles is preferably 0.008 mass %·g/m² or more.

The ratio of the mass oxygen concentration relative to the specific surface area of the fine copper particles can be calculated from measured values for the specific surface area and the mass oxygen concentration. The specific surface area can be measured using a nitrogen gas BET adsorption instrument (for example, MACSORB HM-1201 produced by Mountech Co., Ltd.). The mass oxygen concentration can be measured using an oxygen/nitrogen analyzer (for example, TC600 produced by LECO Corporation).

The ratio of the mass carbon concentration relative to the specific surface area of the fine copper particles can be calculated from measured values for the specific surface area and the mass carbon concentration. The specific surface area can be measured using a nitrogen gas BET adsorption instrument (for example, MACSORB HM-1201 produced by Mountech Co., Ltd.). The mass carbon concentration can be measured using a carbon/sulfur analyzer (for example, EMIA-920V produced by Horiba, Ltd.).

### (Coarse Copper Particles)

The bonding material of the present embodiment optionally contains coarse copper particles. The coarse copper particles have copper as a main component. The coarse copper particles preferably contain not less than 95 mass % and not more than 100 mass % of copper element, and more preferably contain 97 mass % or more of copper element relative to 100 mass % of the coarse copper particles. The inclusion of 95 mass % or more of copper element results in the bonding material having excellent sintering properties and even better bonding force.

The mean particle diameter of the coarse copper particles is not less than 3 μm and not more than 11 μm. When the mean particle diameter of the coarse copper particles is 3 μm or more, contraction of the fine copper particles during sintering of the bonding material is reduced, and cracking of a bonded member is inhibited. From this viewpoint, the mean particle diameter of the coarse copper particles is preferably 5 μm or more. When the mean particle diameter of the coarse copper particles is 11 μm or less, the effect of reducing contraction of the fine copper particles is maintained while also enabling sufficient sintering of the bonding material, and bonding strength of a bonded body is not lost. From this viewpoint, the mean particle diameter of the coarse copper particles is preferably 9 μm or less.

The particle size distribution of the coarse copper particles does not overlap with the particle size distribution of the fine copper particles. For example, the particle size distribution of the coarse copper particles can be a particle size distribution having a D10 of 1.9 μm, a D50 of 3.8 μm, and a D90 of 8.2 μm.

No specific limitations are placed on the shape (form) of the coarse copper particles. The shape of the coarse copper particles may be a spherical shape (sphere), an elliptical shape (ellipsoid), a plate shape (flake), or the like, of which, a spherical shape or an elliptical shape is preferable, and an elliptical shape is more preferable.

The coarse copper particles can, for example, be commercially available flake copper such as MA-C03KP produced by Mitsui Mining & Smelting Co., Ltd. or MA-C025KFD produced by Mitsui Mining & Smelting Co., Ltd., or commercially available micro copper such as 1300Y produced by Mitsui Mining & Smelting Co., Ltd.

The mean particle diameter of the coarse copper particles can be determined by observing 10 viewing fields at ×2,000 magnification using a scanning electron microscope (SEM), measuring the particle diameter of each coarse copper particle among all coarse copper particles (copper particles having a particle diameter of 800 nm or more) selected according to the following selection criteria (1) to (5) in the 10 viewing fields, and calculating an arithmetic mean of the measured particle diameters. Note that in the case of a particle that is an ellipse or the like rather than a perfect circle, the major axis is taken to be the particle diameter. The particle size distribution of the coarse copper particles is also determined based on the particle diameters of all coarse copper particles taken as the measurement subjects described above. In a situation in which the mean particle diameter and the particle size distribution of the coarse copper particles are to be determined with the coarse copper particles in the sheet-shaped bonding material, an outermost surface portion of the sheet is observed. In the case of a powder state prior to sheet production, the powder is placed on carbon tape using a spatula, excess powder is removed by an air duster, and the surface of the tape is observed.
(1) Particles that partially protrude outside of a viewing field of an image are not measured.
(2) Particles that have a clear contour and are present in isolation are measured.
(3) Particles that are independent and can be measured as individual particles are measured even when they deviate from the average particle shape.
(4) Overlapping particles for which there is a clear boundary between the particles and for which the overall particle shape can be judged are each measured as an individual particle.
(5) Overlapping particles for which there is not a clear boundary and for which the overall particle shape is unknown are considered to have particle shapes that cannot be judged and are not measured.

### (Mass Ratio of Fine Copper Particles and Coarse Copper Particles)

The content of the fine copper particles relative to the total content of the fine copper particles and the coarse copper particles is not less than 50 mass % and not more than 100 mass %, and is preferably 75 mass % or more, and more preferably 100 mass %. In other words, the content of the coarse copper particles relative to the total content of the fine copper particles and the coarse copper particles is not less than 0 mass % and not more than 50 mass %, and is preferably 25 mass % or less, and more preferably 0 mass %. This makes it possible to obtain a bonding material having sufficient bonding force.

The “content of the fine copper particles relative to the total content of the fine copper particles and the coarse copper particles” in the sheet-shaped bonding material can be calculated by, for example, placing the sheet in an organic solvent such as isopropyl alcohol, performing ultrasonic dispersion to obtain a dispersion liquid, performing centrifugal separation of the dispersion liquid to separate the fine copper particles and the coarse copper particles, and then measuring the weights of the fine copper particles and the coarse copper particles.

### (Reductant)

The reductant is a compound that reduces the fine copper particles and the coarse copper particles. The reductant is preferably a compound that can function as a dispersion medium in which the fine copper particles and the coarse copper particles disperse. The compound that can function as a dispersion medium is preferably a liquid compound at normal temperature, and is more preferably a liquid compound that is vaporized at a high temperature of 150° C. or higher. This means that the reductant is vaporized during bonding and is unlikely to remain in the subsequently described bonded body. Consequently, voids and cracks are less likely to form, and even better bonding force is achieved.

Amine solvents, specific examples of which include ethanolamine, diethanolamine, and triethanolamine, are preferable as the reductant that can function as a dispersion medium in this manner. However, a feature in the present embodiment is that the reductant is composed of triethanolamine from among these examples. This enables bonding with sufficient bonding strength and with low tendency for unevenness between a sinter state of a central section and a sinter state of a pressed edge section at a pressure bonding surface even in low-temperature bonding at 250° C. or lower. Although it is not certain why such effects are achieved by using triethanolamine as the reductant, the inventors consider the reason for this to be as follows. It is presumed that reductant present in proximity to a pressed edge section can easily escape to the outside, whereas reductant present at a pressed central section cannot easily escape to the outside. The use of triethanolamine, which is a reductant having a high boiling point and low volatility, is thought to make it difficult for the reductant to escape to the outside even at a pressed edge section, thus suppressing unevenness of sintering because the reductant remains present up to a temperature around 200° C. at which reduction of the fine copper particles begins.

The content of the reductant (i.e., triethanolamine) is preferably 1.5 mass % or more, more preferably 3.8 mass % or more, and even more preferably 5.5 mass % or more relative to 100 mass %, in total, of the fine copper particles and the coarse copper particles. This results in even better bonding force upon bonding in a nitrogen atmosphere, and also results in higher bonding force than the bonding force upon bonding in a reducing atmosphere and little unevenness of sintering between pressed central and edge sections.

The content of the reductant (i.e., triethanolamine) is preferably 10.0 mass % or less, and more preferably 7.5 mass % or less relative to 100 mass %, in total, of the fine copper particles and the coarse copper particles. This makes voids and cracks less likely to form, results in even better bonding force, and makes it easier to form the bonding material into the shape of a plate or sheet.

Note that the content of the reductant in the sheet-shaped bonding material is equal to the content of the reductant in the mixture. However, the “content of the reductant” in the sheet-shaped bonding material can be calculated by, for example, measuring the amount of the reductant from the weight loss at from 175° C. to 600° C. in thermogravimetric measurement of the sheet bonding material.

### (Other Components)

The bonding material of the present embodiment may further contain optional components such as a dispersant in addition to the copper particles and the reductant to the extent that the effects according to the present disclosure are not lost. However, the content of optional components is preferably 2 mass % or less relative to the fine copper particles.

### (Sheet Shape)

The bonding material of the present embodiment is sheet-shaped, which makes the bonding material easy to handle compared to a conventional product that is in the form of a paste. In addition, it is easy to maintain dispersion of the fine copper particles even upon long-term storage of the bonding material. Furthermore, there is no need for frozen storage and there is also no need for excessive mixing of a dispersant. Consequently, the bonding material and the subsequently described bonded body have excellent quality.

The bonding material of the present embodiment is a product that is obtained by mixing the copper particles with the required reductant and then pressure forming the resultant mixture to form a sheet shape as described further below. The thickness (pressing direction thickness) of the bonding material is not specifically limited and can be set as not less than 100 μm and less than 1 mm, for example.

Moreover, the shape (shape in plan view from a thickness direction) of the bonding material is not specifically limited and can be selected as appropriate according to the shape of a bonding surface of a bonded member, for example. This shape may be the shape of a pressing surface when the aforementioned mixture is pressure formed at the required pressure to form a sheet shape. Specifically, this shape may be a rectangular shape, a circular shape, or the like, for example.

### [Method of Producing Sheet-Shaped Bonding Material]

A method of producing a sheet-shaped bonding material according to one embodiment of the present disclosure is a suitable method of producing the sheet-shaped bonding material according to one embodiment of the present disclosure set forth above.

Accordingly, details and preferred forms of the fine copper particles, the coarse copper particles, and the reductant are the same as described in the “Sheet-shaped bonding material” section. Moreover, the respective contents of the fine copper particles, the coarse copper particles, and the reductant are also the same as described in the “Sheet-shaped bonding material” section.

In the method of producing a sheet-shaped bonding material of the present embodiment, a mixing step of mixing copper particles (fine copper particles and optional coarse copper particles) and a reductant that reduces the copper particles to obtain a mixture is first performed. No specific limitations are placed on the method by which the copper particles and the reductant are mixed. The mixing method may be a method using a planetary mixer, a mortar, a mill, a stirrer, or the like.

Triethanolamine serving as the reductant is difficult to uniformly mix with the copper particles due to triethanolamine having extremely high viscosity. For this reason, it is preferable that the mixture is obtained by adding an organic solvent to the copper particles and triethanolamine, mixing these materials to obtain a slurry, and then drying the slurry to evaporate the organic solvent. The organic solvent is preferably an alcohol or ketone-based solvent having a low boiling point (lower than 100° C.) and high volatility. The use of an organic solvent having a low boiling point and high volatility is advantageous in terms that the diluting organic solvent, which is superfluous in the bonding material, can easily be removed in a temperature region (lower than 100° C.) where triethanolamine has a low tendency to evaporate, which means that there is almost no change in the concentration of triethanolamine, which is required for reduction and sintering of the copper particles.

In the method of producing a sheet-shaped bonding material of the present embodiment, a pressure forming step of pressure forming the mixture obtained in the mixing step to obtain a sheet-shaped bonding material is subsequently performed. No specific limitations are placed on the method of pressing. The pressing may be performed by a method using a jig made of metal, a compression molding machine, or the like, for example.

The atmosphere during pressing may be an inert atmosphere or an air atmosphere without any specific limitations. However, pressing in air is preferable in terms of convenience.

The pressure during pressing is preferably 10 MPa or higher, and more preferably 40 MPa or higher. When the pressure during pressing is 10 MPa or higher, the bonding material that has been formed into a sheet shape has higher durability. Moreover, a higher pressing pressure results in even higher density of the fine copper particles contained in the bonding material and even higher shear strength at a bonding surface of a bonded body. On the other hand, the pressure during pressing is preferably 500 MPa or lower because cracking of the formed product may arise when there is excessive pressure during pressing.

Although no limitations are placed on the forming temperature during pressing, it is desirable for forming to be performed at normal temperature (10° C. to 30° C.) when considering operability. The forming time during pressing is not specifically limited, but can be set as not less than 1 minute and not more than 10 minutes, for example.

### [Bonded Body]

A bonded body according to one embodiment of the present disclosure includes a first member (first bonded member), a second member (second bonded member), and the bonding material according to one embodiment of the present disclosure set forth above. The bonded body is a bonded product in which a pressed product of the bonding material is located between the first member and the second member and in which the first member and the second member are bonded through the bonding material.

No specific limitations are placed on the materials of the first member and the second member so long as they can be bonded when pressure bonding is performed using the bonding material set forth above. Examples of such materials include metals such as copper, silicon, aluminum, copper oxide, silicon oxide, alumina, silicon nitride, aluminum nitride, boron nitride, and silicon carbide; alloys of these metals; and mixtures of these metals and alloys. The first member and the second member may each be a member in which one type of material is used individually or a member in which two or more types of materials are used together. Moreover, the first member and the second member may be the same material or may be different materials.

The shear strength of a bonding surface of the first member and the second member is preferably 35 MPa or more, more preferably 45 MPa or more, and even more preferably 55 MPa or more. When the shear strength of the bonding surface of the first member and the second member is 35 MPa or more, the bonding material is not easily peeled from the bonded members and bonding reliability is excellent even in a situation in which the bonded body is subjected to repeated heat shock.

The shear strength can be adjusted through the content of the reductant in the bonding material, the pressure during pressure forming of the bonding material, the pressure during bonding, and the atmosphere conditions (reducing atmosphere or inert atmosphere) during bonding.

### [Method of Producing Bonded Body]

A method of producing a bonded body according to one embodiment of the present disclosure includes a step of performing pressing in a state in which the bonding material according to one embodiment of the present disclosure set forth above is arranged between a first member and a second member to obtain a bonded body in which the first member and the second member are bonded through the bonding material.

The bonding conditions can be selected as appropriate according to the materials and combination of the first member and the second member, for example, without any specific limitations. The atmosphere during bonding is preferably an inert atmosphere. The bonding pressure in the inert atmosphere can be set as not lower than 1 MPa and not higher than 40 MPa, for example. The bonding temperature in the inert atmosphere can be set as not lower than 150° C. and not higher than 400° C., for example. In particular, in one embodiment of the present disclosure, good bonding can be realized even when the bonding temperature (atmosphere temperature during bonding) is set to 250° C. or lower. The bonding time in the inert atmosphere can be set as not less than 1 minute and not more than 60 minutes, for example.

### EXAMPLES

### [Production of Bonding Material]

Fine copper particles obtained by a production method described in JP4304221B2 were prepared as a raw material. The copper element content in the obtained fine copper particles was 98.8 mass %. The mean particle diameter of the obtained fine copper particles as determined by the previously described method was 110 nm. The particle size distribution of the obtained fine copper particles had a D10 of 40 nm, a D50 of 110 nm, and a D90 of 300 nm. Moreover, a ratio of the mass oxygen concentration relative to the specific surface area of the obtained fine copper particles was 0.25 mass %·g/m², and a ratio of the mass carbon concentration relative to the specific surface area of the obtained fine copper particles was 0.03 mass %·g/m².

In addition, MA-C03KP produced by Mitsui Mining & Smelting Co., Ltd. (mean particle diameter: 3.8 μm; tap density: 5.26/cm³) was prepared as coarse copper particles. The copper element content in the coarse copper particles was 97.5 mass %. The particle size distribution of the coarse copper particles had a D10 of 1.9 μm, a D50 of 3.8 μm, and a D90 of 8.2 μm. The particle size distributions of the fine copper particles and the coarse copper particles do not overlap.

The fine copper particles and the coarse copper particles were mixed such that the content of the fine copper particles relative to the total content of the fine copper particles and the coarse copper particles was a value shown in Table 1, a reductant of a reductant type shown in Table 1 was added such that the content of the reductant (during mixing) relative to the total content of the mixed fine copper particles and coarse copper particles was a value shown in Table 1, 2-propanol was added as a diluting solvent, and stirring was performed in a planetary mixer to obtain a mixed slurry. Next, 2-propanol was dried from the obtained mixed slurry over 2 hours at 70° C. to obtain a mixture of the fine copper particles, the coarse copper particles (in some examples), and the reductant.

Next, the mixture was loaded into a central hole of a cylindrical jig of 50 mm in length that was made of tungsten carbide and had a hole of 7 mm-square formed in the center thereof. Next, square columns of 7 mm-square that were made of tungsten carbide were inserted from both ends of the central hole in the jig in a perpendicular orientation relative to the central hole, and the mixture was pressed to form the mixture into a sheet shape. The pressure forming was performed for 5 minutes under conditions of a pressure of 74 MPa in normal temperature air. In this manner, a sheet-shaped bonding material of 7 mm-square having a thickness of 250 μm was obtained in each example shown in Table 1. The content of the reductant relative to the total content of the fine copper particles and the coarse copper particles in the sheet-shaped bonding material is equal to the content of the reductant during mixing shown in Table 1.

### [Production of Bonded Body]

Au-plated SiC (5 mm-square, thickness 350 μm) was prepared as a first member, and an oxygen-free copper plate C1020 (20 mm-square, thickness 2 mm) was prepared as a second member. The sheet-shaped bonding material obtained in each example shown in Table 1 was used to perform pressure bonding of the first member and the second member in a 100 volume % nitrogen atmosphere (inert atmosphere) with a bonding temperature (atmosphere temperature) set as a temperature shown in Table 1, a bonding pressure of 10 MPa, and a bonding time of 5 minutes to produce a bonded body of each example shown in Table 1.

### [Evaluation of Shear Strength]

The shear strength of the bonded body was measured using a bond tester (4000Plus produced by Nordson DAGE). The tool height was set as 100 μm and the tool speed was set as 200 μm/s. The result is shown in Table 1.

### [Evaluation of Sintering Properties of Pressure Bonding Surface]

A breaking surface of a bonded sample that had been broken after shear strength measurement was subjected to SEM in order to observe sintering properties of fine copper particles at a central section and an edge section of a pressing surface. An evaluation of “Good” was given in a case in which necking of fine copper particles was confirmed, an evaluation of “Acceptable” was given in a case in which partial necking of fine copper particles was confirmed, and an evaluation of “Unacceptable” was given in a case in which necking of fine copper particles was not confirmed. The result is shown in Table 1.

### [Evaluation of Shape of Bonding Material]

The external appearance of the bonded body was inspected. An evaluation of “Good” was given in a case in which the shape of the bonding material had not collapsed, an evaluation of “Acceptable” was given in a case in which the shape of the bonding material had not collapsed but oozing of reductant was confirmed, and an evaluation of “Unacceptable” was given in a case in which collapse of the shape of the bonding material and seeping of the bonding material from the bonding surface were confirmed. The result is shown in Table 1.

TABLE 1

| | Bonding material | | | | | Evaluation | | | | |
|---|---|---|---|---|---|---|---|---|---|---|
| | Fine | | | | Bonding | | Pressed | Pressed | | |
| | copper | | | | conditions | | central | edge | | |
| | particle | Coarse | | Reductant | Bonding | Shear | section | section | Shape of | |
| | content | particle | | content | temperature | strength | sintering | sintering | bonding | |
| No. | (mass %) | type | Reductant type | (mass %) | (° C.) | (MPa) | properties | properties | material | Classification |
| 1 | 50 | MA-C03KP | Triethanolamine | 3.8 | 250 | 38.0 | Good | Good | Good | Example |
| 2 | 75 | MA-C03KP | Triethanolamine | 3.8 | 250 | 57.1 | Good | Good | Good | Example |
| 3 | 100 | — | Triethanolamine | 3.8 | 250 | >80.0 | Good | Good | Good | Example |
| 4 | 100 | — | Triethanolamine | 2.0 | 250 | 48.7 | Good | Good | Good | Example |
| 5 | 100 | — | Triethanolamine | 9.1 | 250 | >80.0 | Good | Good | Acceptable | Example |
| 6 | 100 | — | Triethanolamine | 3.8 | 200 | 24.7 | Good | Acceptable | Good | Example |
| 7 | 100 | — | Triethanolamine | 5.7 | 200 | >80.0 | Good | Good | Good | Example |
| 8 | 100 | — | Triethanolamine | 7.4 | 200 | >80.0 | Good | Good | Good | Example |
| 9 | 100 | — | Triethanolamine | 9.1 | 200 | >80.0 | Good | Good | Acceptable | Example |
| 10 | 100 | — | Triethanolamine | 1.0 | 250 | Not bonded | | | | Comparative |
| | | | | | | | | | | Example |
| 11 | 100 | — | Triethanolamine | 10.7 | 250 | Sheet formation not possible | | | | Comparative |
| | | | | | | | | | | Example |
| 12 | 50 | MA-C03KP | Ethylene glycol | 3.8 | 250 | 29.8 | Good | Unacceptable | Good | Comparative |
| | | | | | | | | | | Example |
| 13 | 100 | — | Ethylene glycol | 3.8 | 250 | 31.9 | Good | Unacceptable | Good | Comparative |
| | | | | | | | | | | Example |
| 14 | 50 | MA-C03KP | Diethanolamine | 3.8 | 250 | 28.4 | Good | Unacceptable | Good | Comparative |
| | | | | | | | | | | Example |
| 15 | 100 | — | Diethanolamine | 3.8 | 250 | 34.8 | Good | Unacceptable | Good | Comparative |
| | | | | | | | | | | Example |
| 16 | 40 | MA-C03KP | Triethanolamine | 3.8 | 250 | 30.0 | Good | Unacceptable | Good | Comparative |
| | | | | | | | | | | Example |

### [Influence of Reductant Type]

Sintering properties were good in Example No. 1 in which triethanolamine was used as a reductant. In contrast, necking could not be confirmed at the edge section in Comparative Example No. 12 in which ethylene glycol was used as a reductant and Comparative Example No. 14 in which diethanolamine was used as a reductant.

### [Influence of Content of Triethanolamine]

Sintering properties were good in Examples Nos. 1 to 9 in which the content of triethanolamine was not less than 1.5 mass % and not more than 10 mass %. In contrast, bonding was not possible in Comparative Example No. 10 in which the content of triethanolamine was 1.0 mass %. Moreover, forming of a sheet shape was not possible in Comparative Example No. 11 in which the content of triethanolamine was 10.7 mass %.

Through results for Examples Nos. 4 and 5 and results for Examples Nos. 6 to 9, higher content of triethanolamine was confirmed to result in higher bonding strength. However, seeping of the bonding material was confirmed in Examples Nos. 5 and 9 in which the content of triethanolamine was 9.1 mass %. This demonstrates that the content of triethanolamine is preferably 7.5 mass % or less. It should be noted that although seeping of the bonding material was confirmed in Examples Nos. 5 and 9, use as a bonding material was still possible since bonding strength was sufficient and unevenness of sinter states of the central section and edge section did not arise.

### [Influence of Fine Copper Particle Content]

Sintering properties were good in Examples Nos. 1 to 9 in which the content of the fine copper particles relative to the total content of the fine copper particles and the coarse copper particles was 50 mass % or more. In contrast, necking could not be confirmed at the edge section in Comparative Example No. 16 in which the content of the fine copper particles was low.

### [Influence of Bonding Temperature]

Comparatively good results were obtained in Example No. 6 despite sintering properties at the pressed edge section being poor compared to Example No. 3, which had the same bonding material composition as in Example No. 6. Through these results, it was confirmed that bonding is possible even with a bonding temperature of 200° C. when triethanolamine is used as a reductant.

### INDUSTRIAL APPLICABILITY

The sheet-shaped bonding material and method of producing the same and the bonded body and method of producing the same according to the present disclosure have industrial applicability in an application of bonding electronic components. A specific example thereof is an application of bonding components such as boards, elements, etc. in high-temperature environments such as in electronic devices referred to as powder devices where it is difficult to use a bonding material such as solder.

1. A sheet-shaped bonding material comprising copper particles and a reductant that reduces the copper particles, wherein
the copper particles include fine copper particles having a mean particle diameter of 300 nm or less and optionally include coarse copper particles having a mean particle diameter of not less than 3 μm and not more than 11 μm,
content of the fine copper particles relative to the total content of the fine copper particles and the coarse copper particles is not less than 50 mass % and not more than 100 mass %, and
the reductant is composed of triethanolamine, and content of the triethanolamine is not less than 1.5 mass % and not more than 10.0 mass % relative to the total content of the fine copper particles and the coarse copper particles.

2. The sheet-shaped bonding material according to claim 1, wherein a ratio of mass oxygen concentration relative to specific surface area of the fine copper particles is not less than 0.1 mass %·g/m² and not more than 1.2 mass %·g/m².

3. The sheet-shaped bonding material according to claim 1, wherein a ratio of mass carbon concentration relative to specific surface area of the fine copper particles is not less than 0.008 mass % g/m² and not more than 0.3 mass %·g/m².

4. A method of producing a sheet-shaped bonding material comprising:
a mixing step of mixing copper particles and a reductant that reduces the copper particles to obtain a mixture; and
a pressure forming step of pressure forming the mixture to obtain a sheet-shaped bonding material, wherein
the copper particles include fine copper particles having a mean particle diameter of 300 nm or less and optionally include coarse copper particles having a mean particle diameter of not less than 3 μm and not more than 11 μm,
content of the fine copper particles relative to the total content of the fine copper particles and the coarse copper particles in the mixture is not less than 50 mass % and not more than 100 mass %, and
the reductant is composed of triethanolamine, and content of the triethanolamine in the mixture is not less than 1.5 mass % and not more than 10.0 mass % relative to the total content of the fine copper particles and the coarse copper particles.

5. The method of producing a sheet-shaped bonding material according to claim 4, wherein the mixing step includes: a step of mixing the copper particles, the reductant, and an organic solvent to obtain a slurry; and a step of drying the slurry to obtain the mixture.

6. A bonded body comprising a first member, a second member, and the bonding material according to claim 1, wherein the bonding material is located between the first member and the second member.

7. A method of producing a bonded body comprising a step of performing pressing in a state in which the bonding material according to claim 1 is arranged between a first member and a second member to obtain a bonded body in which the first member and the second member are bonded through the bonding material.

8. The method of producing a bonded body according to claim 7, wherein a bonding temperature is set to 250° C. or lower.
